(19) United States
(12) Patent Application Publication
(10) Pub. No.: US 2024/0112682 A1
(43) Pub. Date: Apr. 4, 2024

(54) SPEAKER IDENTIFICATION METHOD, SPEAKER IDENTIFICATION DEVICE, AND NON-TRANSITORY COMPUTER READABLE RECORDING MEDIUM

(71) Applicant: Panasonic Intellectual Property Corporation of America, Torrance, CA (US)

(72) Inventors: Takahiro KAMAI, Kyoto (JP); Misaki DOI, Osaka (JP); Katsunori DAIMO, Osaka (JP); Kousuke ITAKURA, Osaka (JP)

(73) Assignee: Panasonic Intellectual Property Corporation of America, Torrance, CA (US)

(21) Appl. No.: 18/532,054

(22) Filed: Dec. 7, 2023

Related U.S. Application Data
(63) Continuation of application No. PCT/JP2022/020878, filed on May 19, 2022.

(30) Foreign Application Priority Data
Jun. 11, 2021 (JP) 2021-097888

(51) Int. Cl. G10L 17/06; G06F 16/68; G10L 15/02

(52) U.S. Cl. CPC G10L 17/06; G06F 16/68; G10L 15/02; G10L 2015/025

(57) ABSTRACT

An utterer identification device executes: performing voice recognition from input utterance data; selecting, from among a plurality of registered utterance contents set in advance, a registered utterance content closest to a recognized utterance content indicated by a result of the voice recognition as a selected utterance content; selecting, from among a plurality of databases respectively associated with the registered utterance contents, a database associated with the selected utterance content; calculating a similarity between a feature quantity of the input utterance data and a feature quantity stored in the selected database; and identifying a certain utterer on the basis of the similarity, and outputting a result of the identification.

### TECHNICAL FIELD

This disclosure relates to a technology of identifying a certain utterer.

### BACKGROUND ART

Patent Literature 1 discloses a technology of; obtaining a speech content of an input pattern and a speech content of a reference pattern by speech recognition, the reference pattern being preliminarily registered for each of registered speakers or utterers; determining, on the basis of information about the obtained speech content, an identical section in which the speech content of the input pattern and the speech content of the reference pattern are identical to each other; obtaining a difference between the input pattern and the reference pattern in the identical section; and recognizing, on the basis of the obtained difference, an utterer having uttered an input speech.

Non-patent Literature 1 discloses a technology of identifying a certain utterer by comparing a feature quantity of a voice concerning a fixed keyword set in advance for each of registered utterers with a feature quantity of an utterance by the certain utterer concerning the fixed keyword.

However, each of the conventional technologies fails to identify a certain utterer when an utterance of the certain utterer is not identical to a preliminarily registered utterance content of a registered utterer, and thus needs further improvement.

### CITATION LIST

### Patent Literature

Patent Literature 1: Japanese Patent Publication No. 3075250

### Non-Patent Literature

Non-patent Literature 1: Hiroshi Fujimura, Ning Ding, Daichi Hayakawa and Takehiko Kagoshima, “Simultaneous Flexible Keyword Detection and Text-dependent Speaker Recognition for Low-resource Devices”, Proceedings of the 9th International Conference on Pattern Recognition Applications and Methods (ICPRAM 2020), pages 297-307

### SUMMARY OF INVENTION

This disclosure has been achieved to solve the drawbacks, and has an object of providing a technology of identifying a certain utterer even when an utterance content of the certain utterer is not identical to an utterance content of a registered utterer that is preliminarily registered.

An utterer identification method according to one aspect of the present disclosure is an utterer identification method for an utterer identification device that identifies a certain utterer. The utterer identification method includes: acquiring input utterance data being utterance data concerning an utterance of the certain utterer; performing voice recognition from the input utterance data; selecting, from among a plurality of registered utterance contents set in advance, a registered utterance content closest to a recognized utterance content indicated by a result of the voice recognition as a selected utterance content; selecting, from among a plurality of databases respectively associated with the registered utterance contents, a database associated with the selected utterance content, each of the databases storing a feature quantity of utterance data concerning a registered utterance content having been uttered by a registered utterer; calculating a similarity between a feature quantity of the input utterance data and the feature quantity stored in the selected database; and identifying the certain utterer on the basis of the similarity, and outputting a result of the identification.

This disclosure achieves identification of a certain utterer even when an utterance content of the certain utterer is not identical to an utterance content of a registered utterer that is preliminarily registered.

### BRIEF DESCRIPTION OF DRAWINGS

FIG. 1 is a block diagram showing an example of a configuration of an utterer identification device 1 in an embodiment.

FIG. 2 is a table showing an example of a data configuration of a database.

FIG. 3 is a flowchart showing an example of a process by the utterer identification device in the embodiment.

### DESCRIPTION OF EMBODIMENTS

Knowledge Forming the Basis of the Present Disclosure

A known utterer identification technology includes: acquiring utterance data of a certain utterer to be identified; comparing a feature quantity of the acquired utterance data with a feature quantity of utterance data of each of registered utterers; and determining whether the certain utterer is identical to any one of the registered utterers. It has been found from the utterer identification technology that a similarity between feature quantities of utterance data decreases for different utterance contents uttered even by an identical utterer, and a similarity between feature quantities of utterance data increases for the same utterance contents uttered even by different utterers. In other words, the knowledge that the similarity significantly depends on an utterance content has been acquired.

The technology of Patent Literature 1 is established on the premise that a reference pattern has an identical section in which a speech content of an input pattern uttered by a certain utterer is identical to an utterance content of the reference pattern, and thus has a drawback of a failure in identifying the certain utterer when an utterance of the certain utterer has no content falling within such an identical section.

The technology of Non-patent Literature 1 is established on the premise that a certain utterer utters a fixed keyword set in advance, and thus does not consider an utterance of a keyword other than the fixed keyword by the certain utterer. In this regard, the technology of Non-patent Literature 1 has a drawback of a failure in identifying the certain utterer when the certain utterer utters such a keyword other than the fixed keyword.

This disclosure has been achieved to solve the drawbacks, and has an object of providing a technology of identifying a certain utterer even when an utterance content of the certain utterer is not identical to an utterance content of a registered utterer that is preliminarily registered.

An utterer identification method according to one aspect of the present disclosure is an utterer identification method for an utterer identification device. The utterer identification method includes: acquiring input utterance data being utterance data concerning an utterance of a certain utterer; performing voice recognition from the input utterance data; selecting, from among a plurality of registered utterance contents set in advance, a registered utterance content closest to a recognized utterance content indicated by a result of the voice recognition as a selected utterance content; selecting, from among a plurality of databases respectively associated with the registered utterance contents, a database associated with the selected utterance content, each of the databases storing a feature quantity of utterance data concerning a registered utterance content having been uttered by a registered utterer; calculating a similarity between a feature quantity of the input utterance data and the feature quantity stored in the selected database; and identifying the certain utterer on the basis of the similarity, and outputting a result of the identification.

This configuration includes: performing voice recognition from input utterance data of a certain utterer; selecting, from among a plurality of registered utterance contents set in advance, a registered utterance content closest to a recognized utterance content indicated by a result of the voice recognition as a selected utterance content; selecting, from among a plurality of databases, a database associated with the selected utterance content; calculating a similarity between a feature quantity of the input utterance data and a feature quantity of a registered utterer stored in the selected database; and identifying the certain utterer on the basis of the calculated similarity. This consequently achieves identification of a certain utterer even when an utterance content of the certain utterer is not identical to an utterance content of a registered utterer that is preliminarily registered.

In the utterer identification method, in the selecting of the selected utterance content, when the registered utterance contents include a registered utterance content identical to the recognized utterance content, the identical registered utterance content may be selected as the selected utterance content.

According to this configuration, when the registered utterance contents include a registered utterance content identical to the recognized utterance content, a database associated with the identical registered utterance content is selected, and the certain utterer is identified by using a feature quantity of the registered utterer stored in the selected database. This succeeds in accurately identifying the certain utterer.

In the utterer identification method, in the selecting of the selected utterance content, when the registered utterance contents include no registered utterance content identical to the recognized utterance content, the closest registered utterance content may be selected as the selected utterance content.

According to this configuration, when the registered utterance contents include no registered utterance content identical to the recognized utterance content, a database associated with the registered utterance content closest to the recognized utterance content is selected, and the certain utterer is identified by using a feature quantity of the registered utterer stored in the selected database. This succeeds in accurately identifying the certain utterer.

In the utterer identification method, in the selecting of the selected utterance content, a registered utterance content which includes all sound elements of the recognized utterance content may be selected from among the registered utterance contents.

According to this configuration, a registered utterance content which includes all sound elements of the recognized utterance content is selected from among the registered utterance contents as the closest registered utterance content. This configuration enables accurate selection of the registered utterance content closest to the recognized utterance content.

In the utterer identification method, in the selecting of the selected utterance content, a registered utterance content which has configuration data closest to configuration data indicating a configuration of sound elements of the recognized utterance content may be selected from among the registered utterance contents.

According to this configuration, a registered utterance content which has configuration data closest to configuration data concerning sound elements of the recognized utterance content is selected from among the registered utterance contents. This configuration enables accurate selection of the registered utterance content closest to the recognized utterance content.

In the utterer identification method, the sound element may include a phoneme.

This configuration adopts a phoneme as the sound element, and thus enables accurate selection of the registered utterance content closest to the recognized utterance content.

In the utterer identification method, the sound element may include a vowel.

This configuration adopts a vowel as the sound element, and thus enables accurate selection of the registered utterance content closest to the recognized utterance content.

In the utterer identification method, the sound element may include a phoneme sequence in each of n-syllabified phonemic units of an utterance content, “n” being an integer of two or larger.

This configuration adopts a phoneme sequence as the sound element, and thus enables accurate selection of the registered utterance content closest to the recognized utterance content.

In the utterer identification method, the configuration data may include a vector which is defined by allocation of a value corresponding to an occurrence frequency of one or more sound elements of the recognized utterance content or the registered utterance content to a positional arrangement of all sound elements set in advance.

This configuration enables expression of the recognized utterance content or the registered utterance content with the vector representing the feature of the sound element, and thus facilitates calculation of the similarity between the registered utterance content and the recognized utterance content.

In the utterer identification method, the value corresponding to the occurrence frequency may be defined by an occurrence frequency proportion of each of the one or more sound elements that occupies a total number of sound elements of the recognized utterance content or the registered utterance content.

This configuration defines the value corresponding to the occurrence frequency by an occurrence frequency proportion of each of the sound elements that occupies a total number of sound elements of the recognized utterance content or the registered utterance content, and thus enables accurate expression of a feature of each sound element of an utterance content by using the vector.

An utterer identification device according to another aspect of the disclosure includes: an acquisition part that acquires input utterance data being utterance data concerning an utterance of a certain utterer; a recognition part that performs voice recognition from the input utterance data; a first selection part that selects, from among a plurality of registered utterance contents set in advance, a registered utterance content closest to a recognized utterance content indicated by a result of the voice recognition as a selected utterance content; a second selection part that selects, from among a plurality of databases respectively associated with the registered utterance contents, a database associated with the selected utterance content, each of the databases storing a feature quantity of utterance data concerning a registered utterance content having been uttered by a registered utterer; a similarity calculation part that calculates a similarity between a feature quantity of the input utterance data and the feature quantity stored in the selected database; and an output part that identifies the certain utterer on the basis of the similarity, and outputs a result of the identification.

With this configuration, it is possible to provide an utterer identification device that exerts operational effects equivalent to those of the utterer identification method described above.

An utterer identification program according to still another aspect of the disclosure is an utterer identification program that causes a computer to serve as an utterer identification device. The utterer identification program includes: causing the computer to execute: acquiring input utterance data being utterance data concerning an utterance of a certain utterer; performing voice recognition from the input utterance data; selecting, from among a plurality of registered utterance contents set in advance, a registered utterance content closest to a recognized utterance content indicated by a result of the voice recognition as a selected utterance content; selecting, from among a plurality of databases respectively associated with the registered utterance contents, a database associated with the selected utterance content, each of the databases storing a feature quantity of utterance data concerning a registered utterance content having been uttered by a registered utterer; calculating a similarity between a feature quantity of the input utterance data and the feature quantity stored in the selected database; and identifying the certain utterer on the basis of the similarity, and outputting a result of the identification.

With this configuration, it is possible to provide an utterer identification program that exerts operational effects equivalent to those of the utterer identification method described above.

This disclosure can be realized as an information updating system caused to operate by the utterer identification program as well. Additionally, it goes without saying that the utterer identification program is distributable as a non-transitory computer readable storage medium like a CD-ROM, or distributable via a communication network like the Internet.

An embodiment which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in the embodiment.

### Embodiment

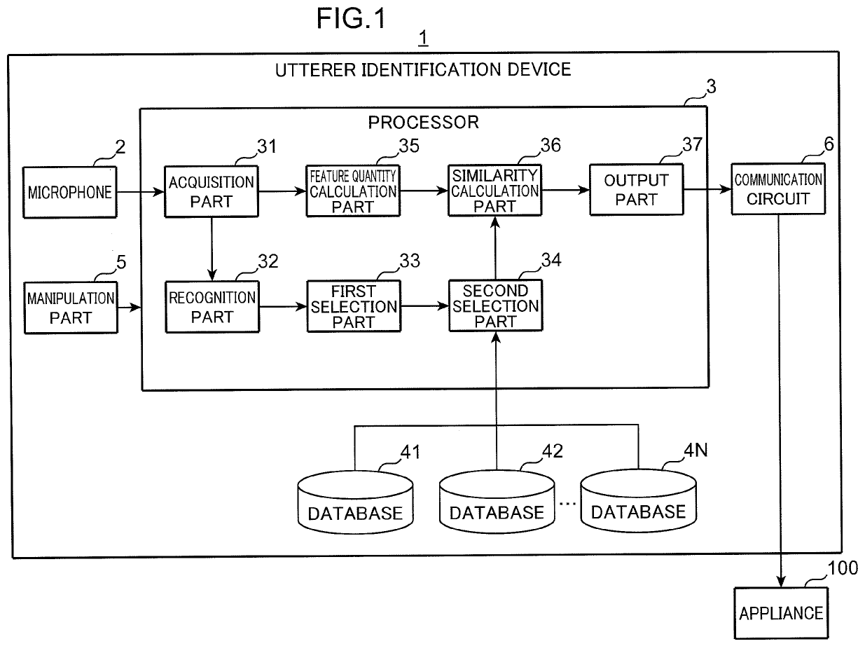

FIG. 1 is a block diagram showing an example of a configuration of an utterer identification device 1 in an embodiment of this disclosure. The utterer identification device 1 identifies a certain utterer on the basis of utterance data being voice data concerning an utterance of the certain utterer. The certain utterer represents an utterer who has not been identified by the utterer identification device 1. The utterer identification device 1 is mounted on, for example, a smart speaker. However, this is just an example, and the utterer identification device 1 may be mounted on a mobile information processing device, such as a smartphone and a tablet-type computer, or may be mounted on a stationary information processing apparatus, such as a desktop personal computer.

The utterer identification device 1 includes a microphone 2, a processor 3, N-databases 41, 42, . . . , and 4N (N≥2), a manipulation part 5, and a communication circuit 6. The N-databases 41, 42, . . . , and 4N are collectively called a “database 4”.

The microphone 2 takes a sound signal including a voice uttered by an utterer and inputs the taken sound signal into an acquisition part 31.

The processor 3 includes, for example, a central processing unit, and has the acquisition part 31, a recognition part 32, a first selection part 33, a second selection part 34, a feature quantity calculation part 35, a similarity calculation part 36, and an output part 37. Each of the acquisition part 31 to the output part 37 comes into effect when the processor executes an utterer identification program to cause a computer to serves as the utterer identification device 1. However, this is just an example, and each of the acquisition part 31 to the output part 37 may be established in the form of a dedicated semiconductor circuit, such as the ASIC (application specific integrated circuit).

The acquisition part 31 acquires input utterance data being utterance data concerning an utterance of the certain utterer from the sound signal input from the microphone 2. For instance, the acquisition part 31 may acquire the input utterance data by detecting an utterance unit from the input sound signal and outputting an acoustic feature quantity in the detected utterance unit. The acoustic feature quantity is indicated by, for example, a Mel frequency cepstral coefficient (MFCC) or a spectrogram. The acquisition part 31 may be triggered by an input of a start instruction from the manipulation part 5 to take the sound signal from the microphone 2, and acquire the input utterance data from the taken sound signal.

The recognition part 32 executes voice recognition from the input utterance data input from the acquisition part 31, generates a recognized utterance content indicating a recognized utterance content, and inputs the generated recognized utterance content into the first selection part 33. The recognized utterance content includes text data expressing the input utterance data with letters. The recognition part 32 may generate the recognized utterance content by using a known voice recognition way. For instance, the recognition part 32 specifies a phoneme constituting utterance data by applying an acoustic model, such as a hidden Markov model, to the acoustic feature quantity of the utterance data, specifies a word constituting the utterance data by applying a pronunciation dictionary to the specified phoneme, and generates an utterance content by applying a language model, such as the N-gram model, to the specified word.

The first selection part 33 selects, from among a plurality of registered utterance contents set in advance, a registered utterance content closest to the recognized utterance content input from the recognition part 32 as a selected utterance content. The databases 41, 42, . . . , and 42N are associated with N-registered utterance contents. The registered utterance contents mean the N-registered utterance contents. Each registered utterance content includes, for example, a command to an appliance 100. Examples of the command include a content “terebitukete (or turn on the television)” for turning on a power source of a television, a content “syoumeitukete (or turn on the light)” for turning on a lighting device, and a content “madowoakete (or open the window)” for opening a window of a mobile vehicle or a house.

Here, when the N-registered utterance contents include a registered utterance content identical to the recognized utterance content, the first selection part 33 may select the identical registered utterance content as the selected utterance content. For instance, when the recognized utterance content indicates “terebitukete” and the registered utterance contents include “terebitukete”, “syoumeitukete”, and “madowoakete”, the content “terebitukete” is selected as the selected utterance content.

By contrast, when the registered utterance contents include no registered utterance content identical to the recognized utterance content, the first selection part 33 may select a registered utterance content closest to the recognized utterance content as the selected utterance content.

For instance, the first selection part 33 may select a registered utterance content which includes all sound elements of the recognized utterance content as the closest registered utterance content. Alternatively, the first selection part 33 may select, as the closest registered utterance content, a registered utterance content which has configuration data closest to configuration data indicating a configuration of sound elements of the recognized utterance content from among the registered utterance contents.

Examples of the sound element include a phoneme, a vowel, and a phoneme sequence. The configuration data includes a vector which is defined by allocation of a value corresponding to an occurrence frequency of one or more sound elements of the recognized utterance content or the registered utterance content to a positional arrangement of all sound elements set in advance.

The value corresponding to the occurrence frequency is defined by an occurrence frequency proportion (hereinafter, referred to as an “occurrence proportion”) of each of the one or more sound elements that occupies a total number of sound elements of the recognized utterance content or the registered utterance content.

Hereinafter, specific examples will be described for selection of the closest registered utterance content when a recognized utterance content indicates “syoumeikesite (or turn off the light)”, and the registered utterance contents include “terebitukete”, “syoumeitukete”, and “madowoakete”.

Case C1: Phenome Serving as a Sound Element

Phenomes are expressed by twenty-six letters of alphabets from “a” to “z”. Configuration data (hereinafter, referred to as “phoneme configuration data”) indicating a configuration of phonemes of an utterance content includes a one-dimensional vector which is defined by allocation of an occurrence proportion of each of the phonemes of the utterance content to a positional arrangement of phonemes set in advance in such a manner that the phenome “a” is allocated in a first position, the phenome “b” is allocated in a second position, . . . and the phenome “z” is allocated in a twenty-sixth position.

For instance, the content “terebitukete” is expressed with phonemes of “terebitukete”. In this regard, phoneme configuration data of “terebitukete” is defined as “0, 1/12, 0, 0, 4/12 . . . , and 0”.

Reasons for the definition will be described below. Specifically, “terebitukete” consists of twelve phonemes, and thus, the total number of phonemes is “twelve”. The occurrence frequency of the phoneme “b” is “once” among the total number “twelve”. That is, the occurrence proportion of the phoneme “b” results in “1/12”. Similarly, the occurrence frequency of the phoneme “e” is “four times”, and thus, the occurrence proportion of the phoneme “e” results in “4/12”. In the phoneme configuration data, when the occurrence frequency of a certain phenome is “zero” time, the occurrence proportion of the phenome results in “0”. In light of the foregoing, the phoneme configuration data of the content “terebitukete” is defined as “0, 1/12, 0, 0, 4/12, . . . , and 0”.

The content “syoumeitukete” is expressed with phonemes of “syoumeitukete”. In this regard, phoneme configuration data is defined as “0, 0, 0, 0, 3/13, . . . , and 0”. The content “madowoakete” is expressed with phonemes of “madowoakete”. In this regard, phoneme configuration data is defined as “2/11, 0, 0, 1/11, 2/11, . . . , and 0”. The content “syoumeikesite” is expressed with phonemes of “syoumeikesite”. In this regard, phoneme configuration data is defined as “0, 0, 0, 0, 3/13, . . . , and 0”.

The first selection part 33 calculates a distance between phoneme configuration data of each of the registered utterance contents and the phoneme configuration data of the recognized utterance content, calculates a similarity therebetween so that the similarity is larger as the distance is shorter, and selects a registered utterance content having the highest similarity resulting from the calculation as the registered utterance content closest to the recognized utterance content.

The distance is, for example, the Euclidean distance. A cosine similarity is, for example, adoptable as the similarity. When the configuration data of the registered utterance content is denoted by a vector v and the configuration data of the recognized utterance content is denoted by a vector v′, the Euclidean distance is expressed by “D(v, v′)=|v−v′|²”. The cosine similarity between the vector v and the vector v′ is expressed by “Σvi*vi′”, where “i” denotes an index of specifying a phoneme.

Case C2: Vowel Serving as a Sound Element

The content “syoumeikesite” includes vowels of “i, u, e, o”. By contrast, the content “terebitukete” includes vowels of “i, u, e”, the content “syoumeitukete” includes vowels of “i, u, e, o”, and the content “madowoakete” includes vowels of “a, e, o”. Among the registered utterance contents, the registered utterance content “syoumeitukete” includes all the vowels of “i, u, e, o” of the recognized utterance content. Accordingly, the first selection part 33 selects the content “syoumeitukete” as the closest utterance content.

When the registered utterance contents include no registered utterance content which includes all the vowels of the recognized utterance content, the first selection part 33 may select a registered utterance content having a configuration closest to a configuration of the vowels of the recognized utterance content as the selected utterance content.

Here, the vowels are expressed with five letters of “a”, “i”, “u”, “e”, and “o”. Configuration data (hereinafter, referred to as “vowel configuration data”) indicating a configuration of vowels of an utterance content includes a one-dimensional vector which is defined by allocation of an occurrence proportion of each of the vowels of the utterance content to a positional arrangement of vowels set in advance in such a manner that the vowel “a” is allocated in a first position, the vowel “i” is allocated in a second position, . . . and the vowel “o” is allocated in a fifth position. In this case, the occurrence proportion is expressed by, for example, an occurrence frequency of each vowel with respect to the total number of vowels of the recognized utterance content or the registered utterance content.

In the same manner as Case C1, the first selection part 33 may calculate a similarity between the vowel configuration data of each of the registered utterance contents and the vowel configuration data of the recognized utterance content, and may select a registered utterance content having the highest similarity resulting from the calculation as the registered utterance content closest to the recognized utterance content.

Case C3: Phenome Sequence Serving as a Sound Element

A phoneme sequence represents a phoneme sequence in each of n-syllabified phonemic units of an utterance content, “n” being an integer of two or larger. The recognized utterance content “syoumeikesite” is expressed with phonemes of “syoumeikesite”. In the case of “n=3”, the phonemes form five syllabified units of “syo”, “ume”, “ike”, “sit”, and “e”. Here, the fifth unit has less than three phonemes, and thus is truncated. Consequently, phoneme sequences of “syoumeikesite” in the case of “n=3” include four elements of “syo”, “ume”, “ike”, and “sit”. Hereinafter each element is called a “sequential element”.

Phoneme sequence configuration data (hereinafter, referred to as “sequential configuration data”) includes a one-dimensional vector which is defined by allocation of an occurrence proportion of each of the sequential elements of the utterance content to a positional arrangement of sequential elements in such a manner that the sequential element “syo” is allocated in a first position, the sequential element “ume” is allocated in a second position, the sequential element “ike” is allocated in a third position, and the sequential element “sit” is allocated in a fourth position. Here, in the sequential configuration data, the order of sequential elements is defined as an occurrence order of the sequential elements of the recognized utterance content, but this is just an example, and another appropriate order may be adoptable.

The content “syoumeitukete” in the case of “n=3” includes sequential elements of “syo”, “ume”, “itu”, and “ket”. Among the sequential elements, the sequential elements “syo” and “ume” are identical to the corresponding sequential elements in the recognized utterance content, and an occurrence frequency of each of the sequential elements is once. Accordingly, the sequential element configuration data of “syoumeitukete” is defined as “1, 1, 0, and 0”. The content “terebitukete” includes sequential elements of “ter”, “ebi”, “tuk”, and “ete”. The elements include no sequential element identical to any one of the sequential elements of the recognized utterance content. Accordingly, the sequential configuration data of “terebitukete” is defined as “0, 0, 0, and 0”. The content “madowoakete” includes sequential elements of “mad”, “owo”, and “ake”. The elements include no sequential element identical to any one of the sequential elements of the recognized utterance content. Accordingly, the sequential configuration data of “madowoakete” is defined as “0, 0, 0, and 0”.

In the same manner as Case C1, the first selection part 33 may calculate a similarity between the sequential configuration data of the recognized utterance content and sequential configuration data of each of the registered utterance contents, and may select a registered utterance content having the highest similarity as an utterance content closest to the recognized utterance content.

The second selection part 34 selects, from among the databases 41, 42, . . . , and 4N, a database 4 associated with a selected utterance content input from the first selection part 33.

For instance, the database 41 is selected, when the registered utterance content “terebitukete” is associated with the database 41, the registered utterance content “syoumeitukete” is associated with the database 42, the registered utterance content “madowoakete” is associated with the database 43, and a selected utterance content indicates “terebitukete”.

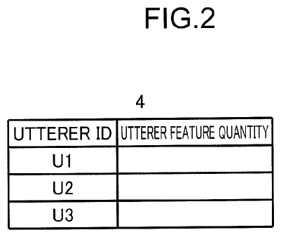

FIG. 2 is a table showing an example of a data configuration of the database 4. The database 4 stores an utterer ID and an utterer feature quantity, which is an example of a feature quantity, in association with each other. The utterer ID is an identifier of a registered utterer. The registered utterer represents an utterer whose utterer feature quantity is registered in the database 4. Examples of the registered utterer include a person related to a facility or a mobile vehicle adopting the utterer identification device 1. Examples of the facility include a house, an office, and a school. Examples of the person related to the facility include a resident of the house, a staff member of the office, and a staff member and a student of the school. Examples of the mobile vehicle include a passenger vehicle, a bus, and a taxi. Examples of the person related to the mobile vehicle include a driver maneuvering the mobile vehicle.

The utterer feature quantity includes a feature quantity of utterance data concerning a registered utterance content having been uttered by the registered utterer. The utterer feature quantity includes a feature quantity suitable for voice recognition, e.g., an i-vector, an x-vector, or a d-vector. In this example, the database 4 stores utterer feature quantities of three registered utterers living in a house. For instance, when the database 4 in FIG. 2 represents the database 4 associated with the registered utterance content “terebitukete”, the database 4 stores utterer feature quantities of utterance data concerning the content “terebitukete” having been uttered by each of the registered utterers U1, U2, and U3. Each utterer feature quantity is registered in an utterer registration phase in advance.

In the utterer registration phase, the utterer identification device 1 causes each of the registered utterers U1, U2, and U3 to utter a plurality of registered utterance contents, takes a sound signal concerning each utterance by the microphone 2, acquires utterance data from the taken sound signal, calculates an utterer feature quantity of the acquired utterance data, and registers the calculated utterer feature quantity in the database 4. When the utterer registration phase finishes, the utterer identification device 1 starts an utterer identification phase.

Referring back to FIG. 1, the feature quantity calculation part 35 calculates an utterer feature quantity of input utterance data input from the acquisition part 31. The utterer feature quantity has the same configuration as that of an utterer feature quantity registered in the database 4. The feature quantity calculation part 35 calculates the utterer feature quantity by using a learned model obtained through machine learning of learning data defining input data as utterance data and defining output data as utterer ID. The learned model is formed of a feature extraction part of the learning model that includes the feature extraction part and an utterer identification part. The feature extraction part extracts the utterer feature quantity of the input utterance data, and inputs the extracted utterer feature quantity into the utterer identification part. The utterer identification part outputs an utterer ID associated with the input utterer feature quantity. In the learning phase, when utterance data is input into the feature extraction part, the feature extraction part and the identification part perform machine learning to output the utterer ID associated with the utterance data as an identification result of the identification part. In a practical phase, the feature extraction part having performed the machine learning in this manner is used as the learned model.

The similarity calculation part 36 calculates a similarity between the utterer feature quantity of the input utterance data input from the feature quantity calculation part 35 and the utterer feature quantity of each registered utterer stored in the database 4 selected by the second selection part 34. The similarity has a higher value as the distance between the utterer feature quantity of the input utterance data and the utterer feature quantity of each registered utterer is shorter. The distance is, for example, the Euclidean distance. The similarity may be, for example, the cosine similarity.

The output part 37 identifies the certain utterer on the basis of the similarity and outputs a result of the identification to the appliance 100 by using the communication circuit 6. For instance, the output part 37 may identify a registered utterer having the highest similarity between the utterer feature quantity of the input utterance data and the utterer feature quantity of each registered utterer as a registered utterer identical to the certain utterer, generate output data including a result of the identification, and output the generated output data to the appliance 100 through the communication circuit 6. The output part 37 may cause the output data to include, for example, an utterer ID of the identified registered utterer as the result of the identification. The output data may further include a registered utterance content selected by the first selection part 33, or an identifier for identifying the registered utterance content.

The manipulation part 5 is an input device including, for example, a touch screen, a mouse, a keyboard, and buttons. The manipulation part 5 receives, for example, a manipulation to give an instruction for starting an utterance from an utterer.

The appliance 100 is provided to a facility or a mobile vehicle, and is communicably connected to the utterer identification device 1. When the utterer identification device 1 provided to the facility, examples of the appliance 100 include an electric appliance to be provided to the facility. Examples of the electric appliance include an air conditioner, a television, a lighting device, a power window, an electric shutter, an electric curtain, a washing machine, a refrigerator, and a microwave oven. When the utterer identification device 1 is provided to the mobile vehicle, examples of the appliance 100 include a car navigation system, a car air conditioner, a car audio system, a windshield wiper or windscreen wiper, a power window, and a controller which controls a drive system of the mobile vehicle.

The appliance 100 and the utterer identification device 1 may be connected to each other via a local area network, e.g., a wireless LAN (Local Area Network), a wired LAN, or a CAN (Controller Area network). When the utterer identification device 1 includes a cloud server, the appliance 100 and the utterer identification device 1 are connected to each other via a broadband network, such as the internet.

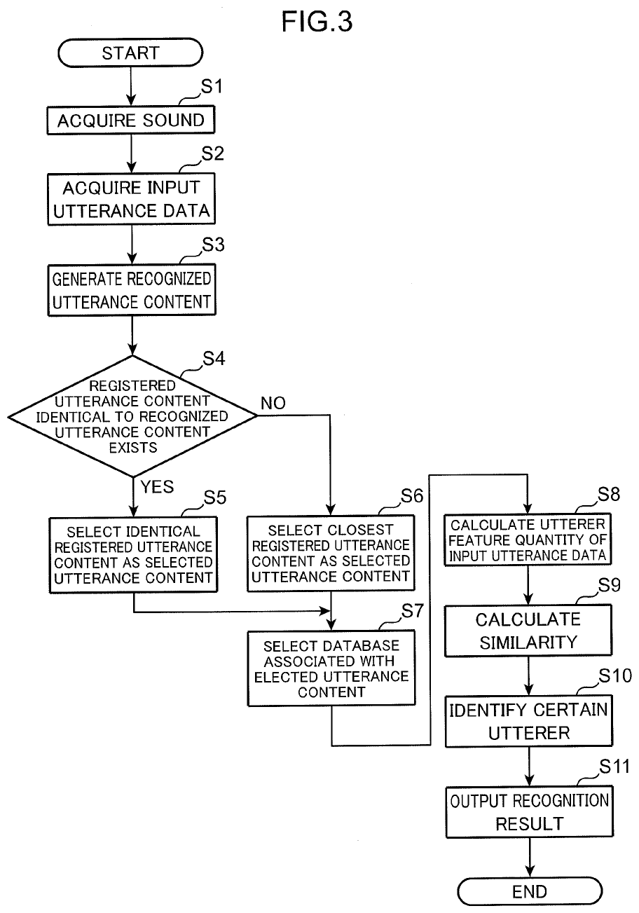

Heretofore, the configuration of the utterer identification device 1 is described. Next, a process by the utterer identification device 1 will be described. FIG. 3 is a flowchart showing an example of the process by the utterer identification device 1 in the embodiment. The process in the flowchart is started, for example, when a certain utterer inputs a manipulation to give an instruction for starting an utterance to the manipulation part 5.

In step S1, the microphone 2 takes a sound signal indicating a voice from an utterance of the certain utterer. In step S2, the acquisition part 31 acquires input utterance data by calculating an acoustic feature quantity in an utterance unit of the utterance from the sound signal taken in step S1. Thus, for example, input utterance data in which a sound signal indicating “syoumeikesite” is expressed by an acoustic feature quantity is acquired.

In step S3, the recognition part 32 generates a recognized utterance content by performing voice recognition from the input utterance data. In this manner, a recognized utterance content is generated by converting the input utterance data into text data.

In step S4, the first selection part 33 determines whether a registered utterance content identical to the recognized utterance content exists. In this case, the first selection part 33 may determine an identicality by comparing the text data of the recognized utterance content with text data of each registered utterance content.

When an identical registered utterance content exists (YES in step S4), the first selection part 33 selects the identical registered utterance content as a selected utterance content (step S5), and leads the process to step S7.

By contrast, when no identical registered utterance content exists (No in step S4), the first selection part 33 selects, from among a plurality of registered utterance contents, a registered utterance content closest to the recognized utterance content as the selected utterance content (step S6). For instance, the first selection part 33 may select a registered utterance content closest to the recognized utterance content by using a way of defining, as a sound element, any one of a phoneme, a vowel, and a phoneme sequence each constituting the recognized utterance content as described above. For example, when no registered utterance content is identical to the recognized utterance content “syoumeikesite”, a registered utterance content closest to the content “syoumeikesite” is selected as a selected utterance content.

In step S7, the second selection part 34 selects, from among the databases 41, 42, . . . , and 4N, a database 4 associated with the selected utterance content.

In step S8, the feature quantity calculation part 35 inputs the input utterance data acquired in step S1 into a learned model, and calculates an utterer feature quantity of the input utterance data.

In step S9, the similarity calculation part 36 calculates a similarity between the utterer feature quantity of the input utterance data and an utterer feature quantity of each registered utterer stored in the database 4 selected in step S7. For instance, when the selected database 4 registers, for example, three registered utterers, similarities concerning the three registered utterers are calculated respectively.

In step S10, the output part 37 identifies a registered utterer having the highest similarity among the similarities calculated in step S9 as the certain utterer. For instance, when the registered utterer U1 has the highest similarity among the registered utterers U1, U2, and U3, the registered utterer U1 is identified as the certain utterer.

In step S11, the output part 37 generates output data including an utterer ID indicating a result of the identification and the registered utterance content, and transmits the generated output data to the appliance 100 by using the communication circuit 6.

As described heretofore, the utterer identification device 1 is configured to: perform voice recognition from input utterance data of a certain utterer; select, from among a plurality of registered utterance contents set in advance, a registered utterance content closest to a recognized utterance content indicated by a result of the voice recognition as a selected utterance content; select, from among the databases 41, 42, . . . , and 4N, a database 4 associated with the selected utterance content; calculate a similarity between an utterer feature quantity of a registered utterer stored in the selected database 4 and an utterer feature quantity of the input utterance data; and identify the certain utterer on the basis of calculated similarity. This consequently achieves identification of a certain utterer even when an utterance content of the certain utterer is not identical to an utterance content of a registered utterer that is preliminarily registered.

Hereinafter, use cases of the utterer identification device 1 will be described. One example use case is a control of a mobile vehicle by receiving, in the mobile vehicle, only a command uttered from a driver to the mobile vehicle. This prevents the mobile vehicle from being controlled by a command uttered by a person other than the driver, and thus ensures safety of the mobile vehicle.

Another example use case is a control of an appliance 100 in a house by a person staying in the house using a voice of the person. In this case, the appliance 100 may determine a preference of the person from an input history of the person having uttered a command, and may operate in a control mode and a user interface suitable for the determined preference.

This disclosure can adopt modifications described below.
(1) In case C2, when a plurality of registered utterance contents includes all the vowels of the recognized utterance content, the first selection part 33 may select, as a registered utterance content closest to the recognized utterance content, a registered utterance content having the highest similarity between the vowel configuration data of the recognized utterance content and vowel configuration data of the registered utterance content.
(2) Although the sound element includes any one of a phoneme, a vowel, and a phoneme sequence in the embodiment, this disclosure is not limited thereto, and the closest registered utterance content may be selected by a combination of any of the sound elements.

For instance, regarding each of the phoneme, the vowel, and the phoneme sequence, the first selection part 33 may calculate a similarity between the recognized utterance content and each registered utterance content, calculate a total similarity for each of the registered utterance contents by adding each calculated similarity per the registered utterance content, and select a registered utterance content having the highest total similarity as the closest registered utterance content.

Alternatively, the first selection part 33 may select a registered utterance content closest to the recognized utterance content by using phoneme configuration data or phoneme sequence configuration data when failing to uniquely specify the closest registered utterance content by using a vowel. Examples of such a failure in unique specifying include: absence of even one registered utterance content including all the vowels of the recognized utterance content; and an existence of a plurality of registered utterance contents each including all the vowels of the recognized utterance content.
(3) Although the first selection part 33 selects a registered utterance content closest to the recognized utterance content by using configuration data when the sound element includes a phoneme or a phoneme sequence in the embodiment, this is just an example. For instance, the first selection part 33 may select a registered utterance content including all the phonemes or phoneme sequences of the recognized utterance content as the closest registered utterance content. In this case, the first selection part 33 may uniquely specify a registered utterance content by using the above-described phoneme configuration data or phoneme sequence configuration data when failing to uniquely selecting a registered utterance content including all the phonemes or phoneme sequences.
(4) A cloud server may include: a part of the blocks constituting the processor 3; and the database 4.
(5) The utterer identification device 1 may be mounted on the appliance 100.

### INDUSTRIAL APPLICABILITY

This disclosure is useful in the technical field of identifying an utterer from a voice.

1. An utterer identification method for an utterer identification device, comprising:
acquiring input utterance data being utterance data concerning an utterance of a certain utterer;
performing voice recognition from the input utterance data;
selecting, from among a plurality of registered utterance contents set in advance, a registered utterance content closest to a recognized utterance content indicated by a result of the voice recognition as a selected utterance content;
selecting, from among a plurality of databases respectively associated with the registered utterance contents, a database associated with the selected utterance content, each of the databases storing a feature quantity of utterance data concerning a registered utterance content having been uttered by a registered utterer;
calculating a similarity between a feature quantity of the input utterance data and the feature quantity stored in the selected database; and
identifying the certain utterer on the basis of the similarity, and outputting a result of the identification.

2. The utterer identification method according to claim 1, wherein,
in the selecting of the selected utterance content, when the registered utterance contents include a registered utterance content identical to the recognized utterance content, the identical registered utterance content is selected as the selected utterance content.

3. The utterer identification method according to claim 1, wherein,
in the selecting of the selected utterance content, when the registered utterance contents include no registered utterance content identical to the recognized utterance content, the closest registered utterance content is selected as the selected utterance content.

4. The utterer identification method according to claim 1, wherein,
in the selecting of the selected utterance content, a registered utterance content which includes all sound elements of the recognized utterance content is selected from among the registered utterance contents.

5. The utterer identification method according to claim 1, wherein,
in the selecting of the selected utterance content, a registered utterance content which has configuration data closest to configuration data indicating a configuration of sound elements of the recognized utterance content is selected from among the registered utterance contents.

6. The utterer identification method according to claim 4, wherein the sound element includes a phoneme.

7. The utterer identification method according to claim 4, wherein the sound element includes a vowel.

8. The utterer identification method according to claim 4, wherein the sound element includes a phoneme sequence in each of n-syllabified phonemic units of an utterance content, “n” being an integer of two or larger.

9. The utterer identification method according to claim 5, wherein the configuration data includes a vector which is defined by allocation of a value corresponding to an occurrence frequency of one or more sound elements of the recognized utterance content or the registered utterance content to a positional arrangement of all sound elements set in advance.

10. The utterer identification method according to claim 9, wherein the value corresponding to the occurrence frequency is defined by an occurrence frequency proportion of each of the one or more sound elements that occupies a total number of sound elements of the recognized utterance content or the registered utterance content.

11. An utterer identification device, comprising:
an acquisition part that acquires input utterance data being utterance data concerning an utterance of a certain utterer;
a recognition part that performs voice recognition from the input utterance data;
a first selection part that selects, from among a plurality of registered utterance contents set in advance, a registered utterance content closest to a recognized utterance content indicated by a result of the voice recognition as a selected utterance content;
a second selection part that selects, from among a plurality of databases respectively associated with the registered utterance contents, a database associated with the selected utterance content, each of the databases storing a feature quantity of utterance data concerning a registered utterance content having been uttered by a registered utterer;
a similarity calculation part that calculates a similarity between a feature quantity of the input utterance data and the feature quantity stored in the selected database; and
an output part that identifies the certain utterer on the basis of the similarity, and outputs a result of the identification.

12. A non-transitory computer readable recording medium storing an utterer identification program that causes a computer to serve as an utterer identification device, the utterer identification program comprising:
causing the computer to execute:
acquiring input utterance data being utterance data concerning an utterance of a certain utterer;
performing voice recognition from the input utterance data;
selecting, from among a plurality of registered utterance contents set in advance, a registered utterance content identical to or closest to a recognized utterance content indicated by a result of the voice recognition as a selected utterance content;
selecting, from among a plurality of databases respectively associated with the registered utterance contents, a database associated with the selected utterance content, each of the databases storing a feature quantity of utterance data concerning a registered utterance content having been uttered by a registered utterer;
calculating a similarity between a feature quantity of the input utterance data and the feature quantity stored in the selected database; and
identifying the certain utterer on the basis of the similarity, and outputting a result of the identification.
